(19) United States
(12) Patent Application Publication
(10) Pub. No.: US 2007/0028178 A1
(43) Pub. Date: Feb. 1, 2007

(54) Method and system for providing a fully accessible color selection component in a graphical user interface

(76) Inventors: Becky J. Gibson, Westford, MA (US); Cynthia L. Ice, Maynard, MA (US)

Correspondence Address: LOTUS AND RATIONAL SOFTWARE;STEUBING MCGUINNESS, 125 NAGOG PARK, ACTON, MA, 01720, US

(21) Appl. No.: 11/189,349

(22) Filed: Jul. 26, 2005

(51) Int. Cl. G06F 9/00

(52) U.S. Cl. 715/760

(57) ABSTRACT

A system for providing a fully accessible color selection component in a graphical user interface, in which multiple selectable colors are represented using a set of selectable color name display regions, each of which includes a text name for a color and has a background color made up of the selectable color. Additionally, and external to the color name display regions, the disclosed system provides a sample color display region made up of a currently selected color. The background colors in the color name display regions reduce ambiguity in normal display settings by showing the user samples of colors that can be selected. The sample color display region supports high contrast settings that are likely to be used by low vision users. When a user has a high contrast setting selected, the background colors in the color name display regions may not be displayed, and accordingly the color name display regions may only display textual names. However, by providing an image of a currently selected color in the sample color display region, the actual color that is currently selected is still displayed, since images are typically not modified by high contrast settings, which may be useful when selecting a color for an off-screen application. The disclosed system can be implemented using an HTML <select> component. A screen reader program can also be used to speak the color names for each color name display region, and the user does not hear any redundant information about the currently selected color.

### FIELD OF THE INVENTION

The present invention relates generally to user interfaces, and more specifically to a method and system for providing a fully accessible color selection component in a graphical user interface.

### BACKGROUND OF THE INVENTION

As it is generally known, the World Wide Web is a major service on the Internet. The World Wide Web is made up of computer systems referred to as “Web servers” that store and disseminate “Web pages,” which are “rich” documents containing text, graphics, animations and videos. Web pages are typically accessed by the user of a client computer system through a Web browser application program running on the client system.

HyperText Mark-up Language (“HTML”) is used to format content presented on the Web. The HTML for a Web page defines page layout, fonts and graphic elements, as well as hypertext links to other documents on the Web. A Web page is typically built using HTML “tags” embedded within the text of the page. An HTML tag is a code or command used to define a format change or hypertext link. HTML tags are surrounded by the angle brackets “<” and “>”.

In consideration of users having a range of capabilities and preferences, it is desirable to provide a full range of access options with regard to Web pages, including mouse, keyboard, and screen reader program accessibility. In particular, users that have suffered an injury or disability, or that are visually impaired, may have difficulty using a mouse, and accordingly may rely on keyboard access and/or a screen reader program to interact with a computer. A screen reader program is software that assists a visually impaired user by reading the contents of a computer screen, and converting the text to speech. An example of an existing screen reader program is the JAWS® program offered by Freedom Scientific® corporation.

Additionally, some users with low vision may need high contrast between text and background to be able to read information on the screen. To address this need, computer operating system software sometimes provides a user selectable “high contrast” setting that automatically changes the color scheme of the user interface to a predetermined or user selected high-contrast color scheme. With the growing importance of content provided over the Web, there is a significant need to make Web pages compatible with high contrast operating system settings while providing full keyboard and screen reader access, in addition to mouse click access.

In many situations a user must be allowed to select a color from a set of colors. One practice of existing Web pages has been to create a color selection component using an HTML <select> statement to display a list of text color names to the user. However, that solution has the disadvantage that it does not display samples of the colors from which the user is selecting. For example, using such existing techniques the user may not be shown the exact color the text (e.g. “Pink”) represents, or what the color will it look like when that choice is selected. This is particularly true when the color selection component is used to determine a color for an off-screen color generation so that the user does not immediately see the results of applying a selected color. Many examples of such off-screen color generation processes exist, such as completing a greeting on an Internet greeting card, placing a printing order over the Internet, and others.

For these reasons and others it would be desirable to have a fully accessible color selection component for a Web page that effectively allows a user to see a color before it is selected and/or applied. The color selection component should be accessible to mouse, keyboard, and screen reader users, and effectively support low vision/high contrast operating system settings on a client computer system.

### SUMMARY OF THE INVENTION

To address the above described and other shortcomings of the prior art, a method and system are disclosed for providing a fully accessible color selection component in a graphical user interface. The disclosed system represents multiple selectable colors using a set of selectable color name display regions, each of which includes a text name for a corresponding selectable color and further has a background color made up of the corresponding selectable color. Additionally, and external to the color name display regions, the disclosed system provides a sample color display region made up of a currently selected color, as well as a selected color name display region providing a text name for the currently selected color, also having a background color made up of the currently selected color.

The background colors in the color name display regions reduce ambiguity in normal display settings by showing the user samples of colors that can be selected. The sample color display region supports high contrast settings that are likely to be used by low vision users. When a user has a high contrast setting selected, the background colors in the color name display regions may not be displayed, and accordingly the color name display regions may display textual names with a background color that does not reflect the corresponding selectable color. However, by providing an image of a currently selected color in the sample color display region, the color that is currently selected is still displayed, since images are typically not modified by high contrast settings. This aspect of the disclosed system is particularly useful when color selection is being performed for an off-screen application, and the user cannot see the results of applying the selected color simultaneously with the color selection component.

The disclosed system is compatible with contemporary Web browser application programs, and with screen reader programs, since it can be implemented using an HTML <select> component. The screen reader program can speak the color names for each color name display region, and the user does not hear any redundant information about the currently selected color image.

Thus there is disclosed a fully accessible color selection component for a Web page that allows the user to see a color before it is selected using normal display settings, and before it is applied when a high contrast setting is in use. The disclosed color selection component is accessible to mouse, keyboard, and screen reader users, and supports low vision/high contrast operating system settings on the client computer system. The disclosed color selection component may be conveniently embodied using technologies such as HTML, Dynamic Hyper-Text Mark-up Language (DHTML), or the like, in order to make a fully functional component.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. In order to facilitate a fuller understanding of the present invention, reference is now made to the appended drawings. These drawings should not be construed as limiting the present invention, but are intended to be exemplary only.

FIG. 1 is a simplified representation of a screen display or screen shot in a graphical user interface, showing a first view of a color selection object resulting from operation of an embodiment of the disclosed system;

FIG. 2 is a simplified representation of a screen display or screen shot in a graphical user interface, showing a second view of a color selection object resulting from operation of an embodiment of the disclosed system, in which a current color has been selected;

FIG. 3 is a simplified representation of a portion of a screen display or screen shot in a graphical user interface, showing a third view of a color selection object resulting from operation of an embodiment of the disclosed system, in which a high contrast display setting has been selected;

FIG. 4 is a simplified representation of a portion of a screen display or screen shot in a graphical user interface, showing a fourth view of a color selection object resulting from operation of an embodiment of the disclosed system, in which a current color has been selected, and in which a high contrast display setting has been selected;

FIG. 5 is a flow chart illustrating steps performed during operation of an embodiment of the disclosed system;

FIG. 6 shows a first code example from an embodiment of the disclosed system;

FIG. 7 shows a second code example from an embodiment of the disclosed system; and

FIG. 8 shows a third code example from an embodiment of the disclosed system.

### DETAILED DESCRIPTION OF EXEMPLARY EMBODIMENTS

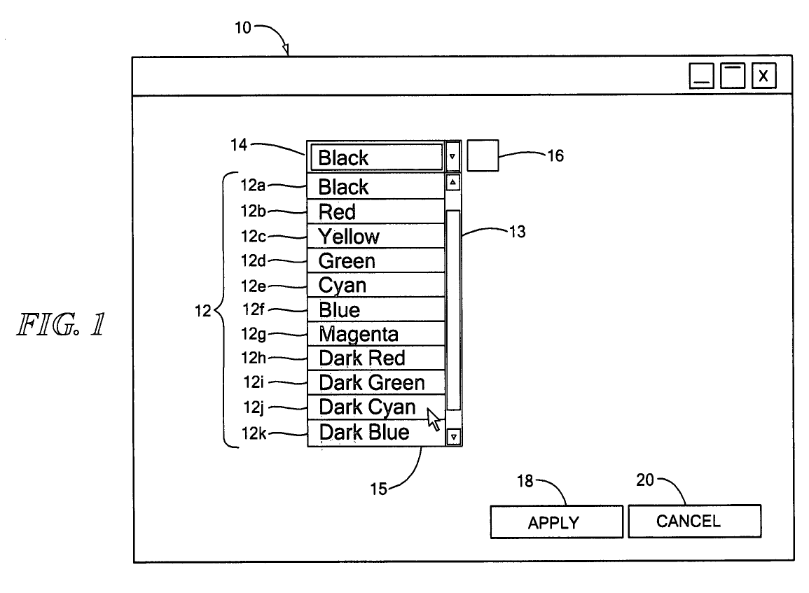

As shown in FIG. 1, a graphical user interface window 10 or the like provided at least in part by an embodiment of the disclosed system includes a color selection component having a set 12 of selectable color name display regions, shown for purposes of illustration by the color name display regions 12a through 12k. In the embodiment of FIG. 1, a scroll bar 13 is provided so that the user can change the currently displayed color name display regions within the set 12. Each of the color name display regions in the set 12 includes a textual name of a corresponding one of a set of selectable colors, and has a background color made up of the corresponding one of the set of selectable colors. Accordingly, for color name display region 12a, the corresponding one of the set of selectable colors is black, the textual name is “Black”, and the background color is black. Similarly, for color name display region 12b, the corresponding one of the set of selectable colors is red, the textual name is “Red”, and the background color is red. The corresponding color for color name display region 12c is yellow, the textual name is “Yellow”, and the background color is yellow, and so on throughout the set 12 of color name display regions. A selected color name display region 14 includes the textual name of the currently selected color, and has a background color made up of the currently selected color. Accordingly, in the example of FIG. 1 and for purposes of illustration, the selected color name display region 14 indicates that the currently selected color is black by having a textual color name of “Black” and a background color black.

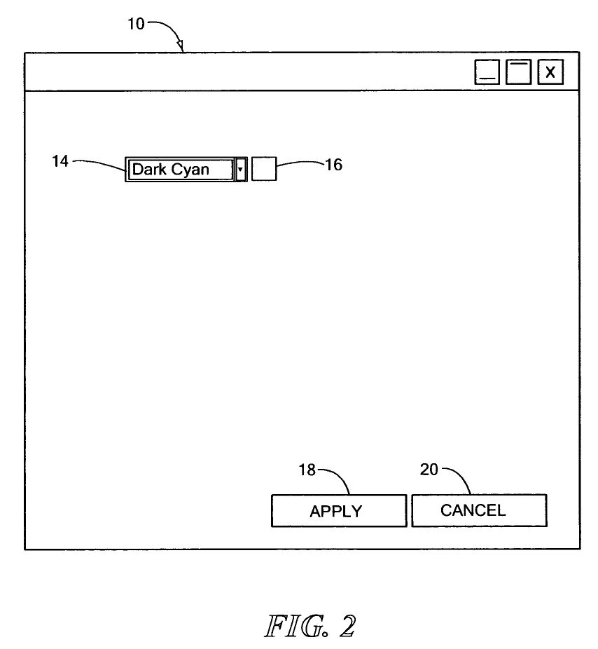

Further in the example of FIG. 1, a sample color display region 16 made up of a currently selected color is provided. Since the color black is the currently selected color in the example of FIG. 1, the sample color display region 16 has the color black. An “Apply” button 18 is also provided in the user interface display of FIG. 1, as an example of a mechanism through which a user can indicate that a currently selected color is to be applied in some way. For example, if a user uses a mouse to click on the “Apply” button 18, the currently selected color may be used as part of some off-screen generation process to create an image or display including the currently selected color in a previously indicated or determined way, such as within a portion, section or field of the generated image or display, as a text color, or in some other way. A cancel button 20 is provided as an example of a mechanism for a user to exit the color selection process without selecting a color. Also in the example of FIG. 1, a cursor 15 is shown hovering over the color name display region 12j corresponding to the color dark cyan, and FIG. 2 illustrates how the user interface display 10 changes as a result of the user clicking on the color name display region 12j.

FIG. 2 shows how the user interface display object 10 changes after a user clicks on the color name display region 12j for the color dark cyan. As shown in FIG. 2, the selected color name display region 14 now includes a textual name “Dark Cyan” and has a background color of dark cyan. In addition, the sample color display region 16 now is made up of the currently selected color dark cyan. If the user were to click on the “Apply” button 16, the color dark cyan would be applied to a previously indicated color definition the user is selecting a color for.

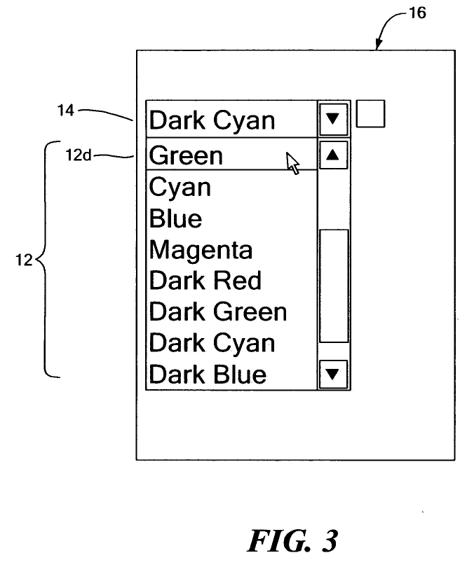

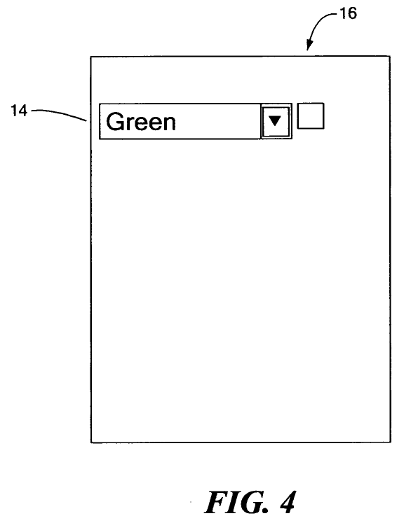

FIG. 3 shows an example of a portion of a display window or the like generated by an embodiment of the disclosed system, and provided within a graphical user interface in which a user has selected a high contrast setting, such as the high contrast setting available through Windows® operating system software provided by Microsoft® Corporation or the like. As shown in FIG. 3, the background colors of the selectable color name display regions 12 have been modified by the high contrast setting, such that they no longer display the corresponding selectable color. The textual names within each of the color name display regions 12 are still present in the example of FIG. 3. Also in the example of FIG. 3, the cursor is hovered over the color name display region 12d for the color green. As a result, the background color of the color name display region 12d is made up of a color defined by the high contrast setting to indicate a display region over which the mouse is currently hovering. If the user were to use the mouse to click on the color name display region 12d, the resulting changes are shown in FIG. 4. As shown in FIG. 4, the selected color name display region 14 now includes the textual name “Green” for the previously selected color, and the sample color display region 16 has been modified to be made up of the currently selected color, in this case green.

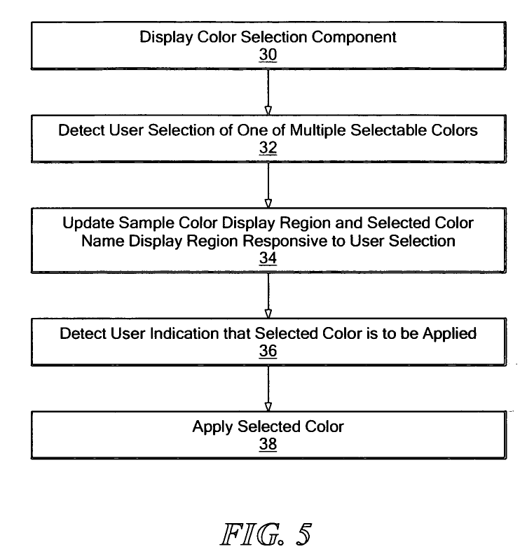

FIG. 5 is a flow chart illustrating steps performed during operation of an embodiment of the disclosed system. At step 30 the disclosed system operates to display a color selection component including multiple selectable color name display regions, a sample color display region, and a selected color name display region. At step 32, the disclosed system detects that a user has selected one of the multiple selectable colors, for example by clicking on a corresponding one of the selectable color name display regions with a mouse, hitting the return key, or in some other specific manner. In response to the user selecting a color at step 32, the embodiment of the disclosed system updates the sample color display region and selected color name display region to reflect the selected color. At step 36, the disclosed system detects that the user has indicated that the selected color is to be applied to a previously determined, and potentially off-screen application. Such indication may be provided through the user clicking on an “Apply” button 18 as shown in FIGS. 1-2, or in any other appropriate manner for a given embodiment. As a result of the detection of the user's indication in step 36, the embodiment of the disclosed system applies the selected color at step 38. Alternatively, application of the selected color may be performed automatically by an embodiment of the disclosed system, without requiring the user to perform a separate indication step.

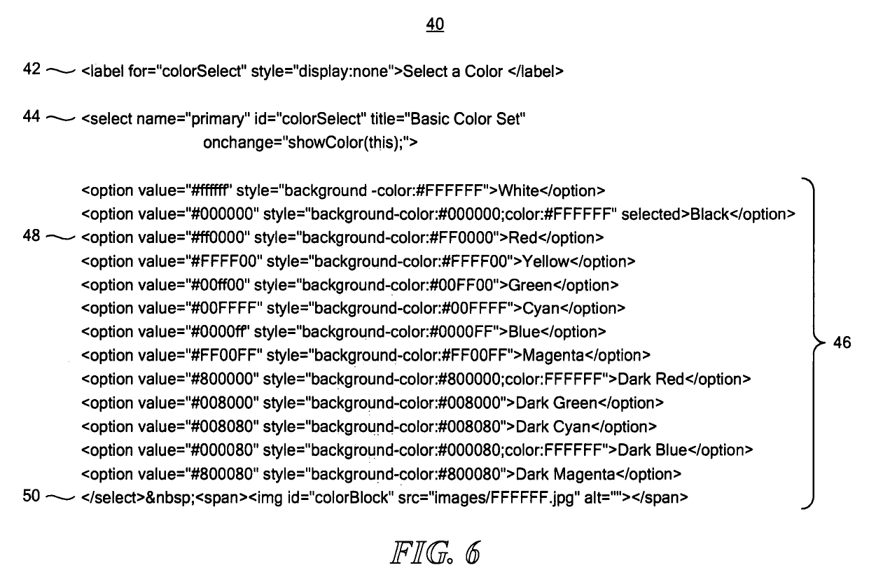

FIG. 6 shows a code example 40 in an embodiment of the disclosed system. As shown in FIG. 6, in addition to the textual name of a selected color, this disclosed system may be embodied to add a background color to each <option> of an HTML <select> statement and also display a sample of the selected color, so the user can actually see a sample of the selected color to be applied. In the embodiment of FIG. 6, the color selection component is created using a HTML <select> statement 44 in which each of the <option> objects 46 within the <select> statement 44 contains the textual description of a corresponding selectable color. Additionally, using Cascading Style Sheets (CSS), each of the <option> objects 46 is styled with a background color to match the textual description. When the user activates the list box generated by the <select> statement 44, a list of selectable color name display regions are displayed. Each color name display region displays the name of the corresponding color, and the background displays the actual color. By using a <select> statement 44, mouse, keyboard, and screen reader accessibility are assured since all major browsers fully support this component.

The <label for=“colorSelect” style=“display:none”>Select a Color </label> code component 42 is an HTML tag to provide a label that is spoken by screen reader programs to announce an HTML component. In the code example 40 of FIG. 6, this component has been styled to be invisible, but the disclosed system is not limited to such an approach.

The <select name=“primary” id=“colorSelect” title=“Basic Color Set” onchange=“showColor(this);” > statement 44 creates the color selection component. With regard to the onchange=“showColor(this);” attribute, showColor( ) is the JavaScript function that will be called when the selected color changes, and this function is used to update a sample color display region, such as the sample color display region 16 of FIGS. 1-4, to represent a currently selected color.

As further illustrated by the embodiment of FIG. 6, an <option> statement is provided for each color. For example, the <option> statement 48 is for the color red, and consists of the following: <option value=“#ff0000” style=“background-color: #FF0000”>Red</option>. The relevant part in each <option> statement is the style attribute, which sets the background color of the <option> to match the textual description of the corresponding color, for example red.

The final line 50 of the code example 40 closes the <select> statement 44, and displays the sample color display region using an image representing the selected color as follows: <select>&nbsp;<span><img id=“colorBlock” src=“images/FFFFFF.jpg” alt=“”></span>. It will be noted that the alt attribute for this image is empty: alt=“”;. The alt attribute is displayed as floating text when the mouse hovers over the sample image. It will also be spoken by screen reader programs when this image is encountered in the document. During operation of the embodiment of FIG. 6, this alt attribute will get updated dynamically by the showColor( ) function when a color is selected by the user. The alt attribute is explicitly initialized to empty by the disclosed system in order to prevent screen reader programs from speaking any information about the image. Because the screen reader program will speak the selected color name, the image provides no additional useful information for the screen reader program user. Accordingly, the screen reader program will not detect any changes made to this image dynamically, so the alt attribute will remain null to the screen reader program, and the screen reader program will not speak unnecessary information about the image.

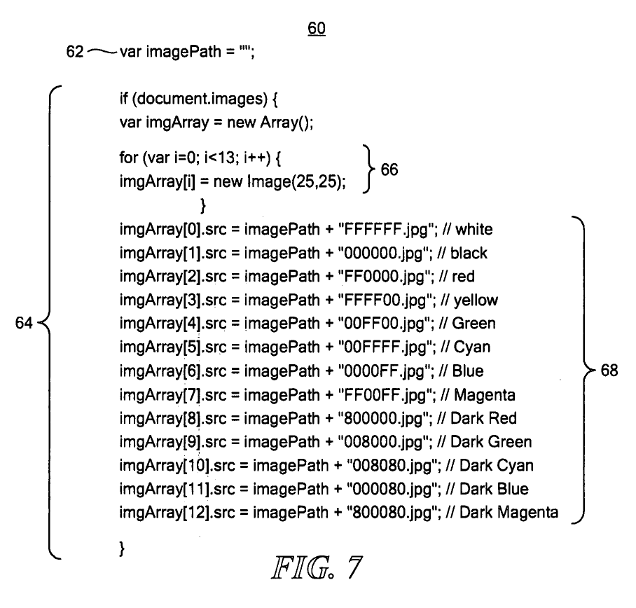

FIG. 7 shows a JavaScript code example 60 in an embodiment of the disclosed system. The JavaScript code example 60 is executed when the example HTML of FIG. 6 is loaded. Those skilled in the art will recognize that the code example 60 of FIG. 7 uses a technique for pre-loading images that is operable on the World Wide Web (Web). The images that are being loaded are color blocks for each color in the color picker. The order that the images are stored in corresponds to the order of the colors in the color select list for this example. The disclosed system is not limited to the approach shown in FIG. 7, and other techniques to match the correct image with the color selection may be used in the alternative.

The statement 62 provides a variable that can be used in the case where the images are stored in a different directory. The code 64 loads the images to be used by the disclosed color selection component. The code 66 creates the image objects that are used, one for each selectable color. The color image array 68 is arranged such that each array element has an index corresponding to the position of the <option> object for the same color in the <select> statement of FIG. 6.

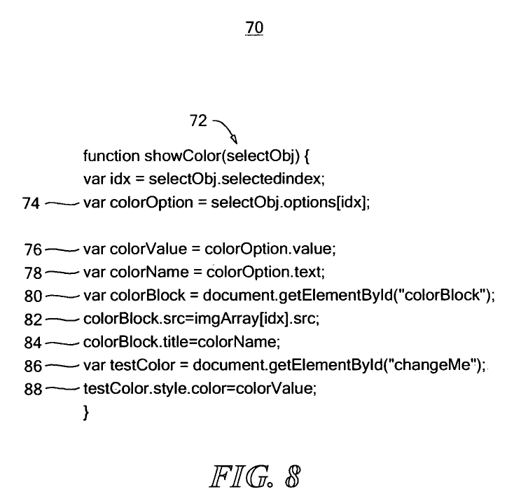

FIG. 8 shows a code example 70 from an embodiment of the disclosed system. As shown in FIG. 8, the code example 70 is a JavaScript function that is called when a color is selected by the user. When the user selects a color through the disclosed color section display object, the onchange event is fired and the showColor( ) function will be called. The selectedObj variable contains the <select> object component that fired the onchange event. From selectedObj the disclosed system determines the index of the color <option> selected by the user. The disclosed system uses that index to find the appropriate image in the array of images 68 shown in FIG. 7. Then the disclosed system updates the sample color display region image object with the src to the new image, and updates its title attribute as well. For purposes of explanation and illustration, and as further described below, the code 70 of FIG. 7 uses the selected color to change the color of some element, within a Web page. The idx variable is the index of the <option> selected, and is used to retrieve the <option> object for the selected color. Idx is also the index into the array of images 68 (FIG. 7) to retrieve the src attribute for the correct color image to display.

The colorValue is stored as the value attribute of each <option> element, and is a hexadecimal triplet beginning with the # character consisting of three pairs of hexadecimal values representing the red, green and blue color values for the color. For purposes of explanation and illustration, the colorValue is used to update an element within a document. The colorName is derived from the text entry of the <option> element. It is used to set the title attribute of the image element. The title attribute is used in the code 70, rather than alt, since it is supported by conventional Web browser applications to display an information pop-up box (“tooltip”) when the mouse pauses over the image.

More particularly, with specific reference to code in the code 70 as shown in FIG. 8, the selectObj parameter 72 is obtained from “this” as shown in the <select> statement 44 in the code example 40 of FIG. 6. Line 74 gets the <option> object for the selected color. Line 76 obtains the value attribute of the <option> selected, which is the color in hexadecimal representation as described above. Line 78 obtains the color name that will be used as the title of the sample color display region for use by a screen reader application and mouse over “tooltip” use. Line 80 finds the colorBlock image object using its identifier. Line 82 sets the src of the image object using idx to find the correct entry. Line 84 sets the title attribute to the color name so it will display in response to a mouse hovering over the image. Line 86 finds an element in a document that will have its color changed to a currently selected color, and line 88 changes the color of that document to the color in the selected colorValue.

The disclosed system provides many advantages over previous approaches. The disclosed system supports low vision users who are likely to use high contrast settings on their computer system. As noted above, when a user has high contrast settings selected, background colors may not display when browsing the Web. As a result, the disclosed color selection object may display only textual names in the color name display regions. However, by providing a sample color image of the currently selected color, the disclosed system enables a high contrast user to see the actual currently selected color selected, since images are typically not modified by high contrast settings. The disclosed system is particularly useful when the color selection is being performed for any type of off-screen image or display generation, where the user cannot immediately see the results of applying the selected color. Many examples of such off-screen applications exist, including entering a greeting for an Internet greeting card, placing a printing order over the Internet, and others. The disclosed system can be embodied to operate using typical Web browser application programs. The disclosed system also works for users that rely on screen reader programs, because it can be implemented using an HTML <select> component. The screen reader program will speak the color names listed for each component. Because of the manner in which the disclosed system can be embodied, the screen reader user need not hear any redundant information regarding the sample selected color image.

FIG. 5 is a flowchart illustration of methods, apparatus(s) and computer program products according to an embodiment of the invention. It will be understood that each block of FIG. 5, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program command structures, one skilled in the art will recognize that they may be embodied using a variety of specific command structures.

We claim:

1. A method of providing an accessible color selection component in a graphical user interface, comprising:
representing multiple selectable colors through a set of selectable color name display regions, wherein each of said color name display regions includes a text name for a corresponding selectable color and further has a background color made up of said corresponding selectable color; and
outside of said color name display regions, providing a sample color display region made up of a currently selected one of said multiple selectable colors.

2. The method of claim 1, wherein said providing said sample color display region comprises displaying an image made up of said currently selected one of said multiple selectable colors.

3. The method of claim 1, wherein said representing and providing are provided through use of a hypertext mark-up language (HTML) select instruction.

4. The method of claim 1, further comprising providing a selectable object enabling a user to apply said currently selected one of said multiple selectable colors to an off-screen generation process.

5. The method of claim 4, wherein said selectable display object enabling said user to apply said currently selected one of said multiple selectable colors comprises a button object.

6. The method of claim 1, further comprising providing a selected color name display region having displayed within it a text name for said currently selected one of said multiple selectable colors, wherein said selected color name display region also as a background color made up of said currently selected one of said multiple selectable colors.

7. A system including a computer readable medium, said computer readable medium having program code stored thereon for providing an accessible color selection component in a graphical user interface, said program code comprising:
program code for representing multiple selectable colors through a set of selectable color name display regions, wherein each of said color name display regions includes a text name for a corresponding selectable color and further has a background color made up of said corresponding selectable color; and
program code for providing, outside of said color name display regions, a sample color display region made up of a currently selected one of said multiple selectable colors.

8. The system of claim 7, wherein said program code for providing said sample color display region comprises program code for displaying an image made up of said currently selected one of said multiple selectable colors.

9. The system of claim 7, wherein said program code for representing and program code for providing include a hypertext mark-up language (HTML) select instruction.

10. The system of claim 7, further comprising program code for providing,a selectable object enabling a user to apply said currently selected one of said multiple selectable colors to an off-screen generation process.

11. The system of claim 10, wherein said selectable display object enabling said user to apply said currently selected one of said multiple selectable colors comprises a button object.

12. The system of claim 7, further comprising program code for providing a selected color name display region having displayed within it a text name for said currently selected one of said multiple selectable colors, wherein said selected color name display region also as a background color made up of said currently selected one of said multiple selectable colors.

13. A computer program product including a computer readable medium, said computer readable medium having stored thereon program code for providing an accessible color selection component in a graphical user interface, said program code comprising:
program code for representing multiple selectable colors through a set of selectable color name display regions, wherein each of said color name display regions includes a text name for a corresponding selectable color and further has a background color made up of said corresponding selectable color; and
program code for providing, outside of said color name display regions, a sample color display region made up of a currently selected one of said multiple selectable colors.

14. A computer data signal embodied in a carrier wave, said computer data signal having program code stored thereon for providing an accessible color selection component in a graphical user interface, said program code comprising:
program code for representing multiple selectable colors through a set of selectable color name display regions, wherein each of said color name display regions includes a text name for a corresponding selectable color and further has a background color made up of said corresponding selectable color; and
program code for providing, outside of said color name display regions, a sample color display region made up of a currently selected one of said multiple selectable colors.

15. A system for providing an accessible color selection component in a graphical user interface, comprising:
means for representing multiple selectable colors through a set of selectable color name display regions, wherein each of said color name display regions includes a text name for a corresponding selectable color and further has a background color made up of said corresponding selectable color; and
means for providing, outside of said color name display regions, a sample color display region made up of a currently selected one of said multiple selectable colors.
